(19) United States
(12) Patent Application Publication
(10) Pub. No.: US 2017/0121520 A1
(43) Pub. Date: May 4, 2017

(54) DIELECTRIC COMPOSITE MATERIAL FOR FINGERPRINT SENSOR INDUCTION LAYER AND PREPARATION METHOD THEREOF

(71) Applicant: TECORE SYNCHEM INC., Tianjin (CN)

(72) Inventors: Xiaohua Tan, Tianjin (CN); Ju Huo, Tianjin (CN); Huiyun Yu, Tianjin (CN); Yakai Feng, Tianjin (CN); Xuyun Sun, Tianjin (CN)

(73) Assignee: TECORE SYNCHEM INC.

(21) Appl. No.: 15/358,120

(22) Filed: Nov. 21, 2016

Related U.S. Application Data
(63) Continuation of application No. PCT/CN2015/072993, filed on Feb. 13, 2015.

(30) Foreign Application Priority Data
Aug. 29, 2014 (CN) 201410437851.2

(51) Int. Cl. C08L 63/00; G06K 9/00; C08L 61/06

(52) U.S. Cl. CPC C08L 63/00; C08L 61/06; G06K 9/0002; C08L 2201/02; B29C 47/0004

(57) ABSTRACT

Provided is a dielectric composite material for a fingerprint sensor induction layer and a preparation method therefor, wherein the dielectric composite material is made from the following components: an epoxy resin, a phenolic resin, a first type of dielectric inorganic filler, a second type of dielectric inorganic filler, a curing agent, an adhesion promoter, a mould releasing agent and a flame retardant. The dielectric composite material has a high dielectric constant, a small dielectric loss, very stable dielectric properties which change very little with the test frequency, non-transparency and high hardness, such that the fingerprint sensor induction layer prepared therefrom satisfies the requirements of reliability and stability while reaching the thickness requirement, and can be used in various portable electronic products. The dielectric composite material for the fingerprint sensor induction layer is free of heavy metal lead, and is green and environmentally friendly. The dielectric composite material has convenience and high safety, and therefore the terminal application thereof can not only replace the existing digital-input password identification system, but can also be used on any electronic component in need of security.

### CROSS-REFERENCE TO RELATED APPLICATIONS

This application is a continuation of International Patent Application No. PCT/CN2015/072993 with a filing date of Feb. 13, 2015, designating the United States, now pending, and further claims priority to Chinese Patent Application No. 201410437851.2 with a filing date of Aug. 29, 2014. The content of the aforementioned applications, including any intervening amendments thereto, are incorporated herein by reference.

### TECHNICAL FIELD

The present invention relates to a dielectric composite material for a fingerprint sensor induction layer and a preparation method thereof.

### BACKGROUND OF THE PRESENT INVENTION

At present, a typical encapsulation structure of a fingerprint sensor includes a silicon wafer on which an induction electrode and relevant circuits are formed. The fingerprint sensor (abbreviated as FPS) plays a role in sensing a relative distance between a ridge and a valley of finger skin of a user in a capacitive electric field and generating an accurate grain image of the ridges and valleys of a fingerprint. In order to guarantee the precision of the sensor, the distance between a finger of the user and the surface of the silicon wafer cannot be too far; and when the distance between the finger and the surface of the silicon wafer is increased, the electric field intensity is decreased, the sensing precision of the sensor becomes worse, and the fingerprint of the user cannot be accurately read. Therefore, the fingerprint sensor requires that a dielectric material protection layer between the induction electrode of the silicon wafer and the finger shall be thinner as far as possible.

However, the fingerprint sensor must have high reliability; and in order to avoid the negative influence of the environment (dampness, perspiration, electrolyte pollution and the like), static electricity and mechanical damage, it is required that the protection layer or an encapsulation layer on the surface of the silicon wafer must have a given thickness. In a standard integrated circuit (IC) encapsulation method for completely encapsulating the silicon wafer, the thickness of an encapsulation material covering the silicon wafer is generally 30-2000 μm, it is apparent that an electric field of the fingerprint sensor cannot penetrate through the encapsulation layer having such a thickness, so the fingerprint cannot be identified. There is contradiction between the sensing precision and the reliability requirement of the fingerprint sensor, therefore, there is absolutely a need for an encapsulation method and encapsulation material giving consideration both to the device reliability and to sensing precision and being simple in preparation and low in cost.

In the prior art, a majority of fingerprint sensors often adopt an incomplete encapsulation method (refer to FIG. 3), i.e. the encapsulation material only covers and protects a contact and a key alloy wire on the silicon wafer, while an induction area where the sensor wafer directly contacts the finger of the user is exposed, and the wafer is prevented from being damaged by static electricity, mechanical damage and the like only by utilizing a protective thin layer with a small thickness. It introduces the application of a thin layer of a material such as silicon nitride, silicon carbide, aluminum oxide and the like in the protection of the sensor wafer and also as a dielectric material layer in a world patent WO2003098541, U.S. Pat. No. 6,091,082, U.S. Pat. No. 6,114,862 and U.S. Pat. No. 6,515,488 and European patents EP1256899 and the like. However, subjected to the limitation of a processing method (a chemical vapor deposition (CVD) method is often used), the thickness of the protection thin layer is generally only hundreds of nanometers to 4 micrometers and cannot be more than 10 micrometers, so that the long-term mechanical abrasion cannot be resisted, and sufficient electrostatic protection and environmental protection cannot be provided for the sensor wafer.

An encapsulation method adopting a transparent or semi-transparent capacitive lens to encapsulate the silicon wafer is used in other encapsulations, and both the device reliability and the sensing precision are taken into account (refer to FIG. 2). Some of these encapsulation ways are already applied to a real product. In a U.S. Pat. No. 5,887,343 and world patents WO20111304093, WO2010120646, it is introduced that a transparent or semi-transparent material with a dielectric constant greater than 5 and less than 20, such as Kapton, electrical glass (3.8-14.5), photographic glass (7.5), pyrex glass (4.6-5.0), window glass (7.6), mica (4.0-9.0) and nylon (3.24-22.4), is made into a sheet-like capacitive lens, epoxy resins or acrylic adhesives are adhered onto the silicon wafer, and the thickness can reach 40-100 micrometers. A patent WO20131737773 of Apple Inc. discloses that anisotropic sapphire is industrializedly used as a capacitive lens material in a portable electronic product such as a mobile phone, adhesive is adhered onto the silicon wafer, and the thickness can reach 40-200 micrometers.

Besides the IC encapsulation process, the lens-encapsulated fingerprint sensor needs additional encapsulation steps such as a pre-cutting step and an adhesion step of the capacitive lens, thereby leading to a complicated encapsulation process of the sensor, and resulting in high manufacturing cost.

In conclusion, the existing silicon wafer encapsulation technologies need complicated encapsulation manufacturing processes, so that the cost is high, but the efficiency is low.

### SUMMARY OF PRESENT INVENTION

The present invention aims at overcoming the shortcomings of the prior arts and providing a dielectric composite material for a fingerprint sensor induction layer.

A second objective of the present invention is to provide a preparation method of a dielectric composite material for a fingerprint sensor induction layer.

A technical solution of the present invention is outlined as follows:

the dielectric composite material for the fingerprint sensor induction layer is prepared from the following components by mass percent:

4 to 20 percent of epoxy resin, 0.2 to 10 percent of phenolic resin, 35.27 to 90 percent of a first type of dielectric inorganic filler, 2 to 60 percent of a second type of dielectric inorganic filler, 0.01 to 5 percent of curing agent, 0.01 to 5 percent of adhesive force accelerant, 0.01 to 3 percent of releasing agent and 0.5 to 10 percent of fire retardant.

The epoxy resin is selected from: at least one of bisphenol A-type epoxy resin with grades of EPO1431310, EPO1441310, EPO1451310, EPO1551310, EPO1661310, EPO1671310 or EPO1691410; or bisphenol F-type epoxy resin with grades of YDF-161, YDF-161H, YDF-162, YDF-165. YDF-170, YDF-175, YDF-175S, YDF-2001, YDF-2004, DER354, NPON862, NPON863, EPICLON830, EPICLON830S, EPICLON830LVP, EPICLON835 or EPICLON835LV; or hydrogenated bisphenol A-type epoxy resin with grades of ST-1000, ST-3000, ST-4000D, ST-40100D, ST-5080, ST-5100 or EPONEX1510; or phenol formaldehyde epoxy resin with grades of F-44, F-52 or F-48; or formaldehyde epoxy resin with a grade of FJ-47 or FJ-43; or o-cresol formaldehyde epoxy resin with grades of PGCN-700-2, PGCN-700-3, PGCN-701, PGCN-702, PGCN-703, PGCN-704L, PGCN-704ML, PGCN-704, PGCN-700-2S, PGCN-700-3S, PGCN-701S, PGCN-702S, PGCN-703S, PGCN-704S, JF-43, JF-45, JF-46, CNE-195XL, KI-3000 and KI-5000; or biphenyl epoxy resin with a grade of YX-4000H, YX-4000K, YX-4000H/K, YL6121H, YL6677, YX7399 and YL6640; or biphenyl-type epoxy resin with a grade of YX-4000H, YX-4000K, YX4000H/K, YL6121H, YL6677, YX7399 and YL6640; or bis(2,3-epoxycyclopentyl) ether, 3,4-epoxy-6-methyl cyclohexane carboxylic acid-3′,4′-epoxy-6′-methyl-cyclohexanemethano formate, a vinyl cyclohexene di-epoxy compound, 3,4-epoxy cyclohexanecarboxylic acid-3′4′-epoxycyclohexane carboxylate, a di-isoprene di-epoxy compound, hexanedioic acid bis(3,4-epoxy-6-methyl-cyclohexanemethano formate), a dicyclopentadlene di-epoxy compound, tetrahydrophthalic acid diglycidyl ester, cyclohexane-1,2-dicarboxylic diglycidyl ester, 4,5-epoxy tetrahydrophthalic acid diglycidyl ester, bis((3,4-epoxy cyclohexyl) methyl) adipate, 1,2-epoxy-4-vinyl cyclohexane, 3,4-epoxy cyclohexyl methyl methacrylate, 1,4-cycohexanedimethanol dis(3,4-epoxy cyclohexanecarboxylic acid) ester or 3-oxiranyl 1,2-cyclohexene oxide.

The phenolic resin is selected from: at least one of ordinary phenolic resin with a grade of 2130, 2127, 2124, 2123, 2402, GS-180, GS-200, P-180, P-200, H-1, H-4 or HF-1M; or biphenyl-type phenolic resin with a grade of MEH-7851S. MEH-7851-3H, MEH-7852M or MEH-7853-SS; or p-t-octylphenol formaldehyde resin with a grade of TXN-203; or p-tert-butylphenol formaldehyde resin with a grade of 2402; or epoxy modified alkyl phenolic resin with a grade of TKM-O, SP1077, T6000 or T3100; or cashew nut oil modified alkyl phenolic resin with a grade of SP6600 (SP6700+HMT), SP6700, SL2201, SL2202, urez12686, PFM-C, HRJ11995, PF221, PF222 or PF223; or tall oil modified alkyl phenolic resin with a grade of SP6601(SP6701+HMT), SP6701, SL2101, SL2102, Durez13355, PFM-T or HRJ12532; or hydroxymethyl p-n-octylphenol formaldehyde resin with a grade of 202, R17152, SP-1044 or SP-10458; or bromo-hydroxymethyl p-n-octylphenol formaldehyde resin with a grade of 201, SP-1055, SP-1056, Tackind250 or P-124; or hydroxymethyl p-tert-butylphenol formaldehyde resin with a grade of 101; or epoxy modified phenolic resin with a grade of PF-231.

The first type of dielectric inorganic filler is preferably selected from: at least one of barium titanate, copper calcium titanate, calcium titanate and barium strontium titanate with a maximum particle size less than 100 μm and an average particle size between 0.8 μm to 50 μm.

The second type of dielectric inorganic filler is preferably selected from: at least one of titanium dioxide, aluminum oxide, silicon dioxide, boron nitride, calcium carbonate and mica with a maximum particle size less than 100 μm and an average particle size between 0.8 μm to 50 μm.

The curing agent is selected from: at least one of ethylenediamine, diethylenetriamine, triethylenetetramine, tetraethylenepentamine, penten, piperazine, N-aminoethylpiperazine, N-hydroxyethyl piperazine, m-phenylenediamine, o-phenylenediamine, diaminodiphenyl-methane, isophoronediamine (IPDA), 1,3-bis(aminomethyl) cyclohexane, 4,4-diamino dicyclohexyl methane, ethanediamine bismaleimide, hexamethylenediamine bismaleimid, m-phenylenediamine bismaleimid, p-aminophenol maleimide, diaminodiphenyl sulfone, phthalazinone, phthalic anhydride, trimellitic anhydride, pyromellitic dianhydride, hydrogenated pyromellitic anhydride, maleic anhydride, tung oil anhydride, dodecenyl succinic anhydride, tetrahydrophthalic anhydride, methyltetrahydrophthalic anhydride, hexahydrophthalic anhydride, methylhexahydrophthalic anhydride, nadic anhydride, methyl nadic anhydride, glutaric anhydride, hydrogenated methyl nadic anhydride, methyl cyclohexene tetracarboxylic dianhydride, polyazelaic polyanhydride, polysebacic polyanhydride, 1,4,5,6-tetrabromophthalic anhydride, 1,8-diazepine bicyclo-[5,4,0]-7-undecene, diazepine bicyclo-nonene, benzoperoxide, di-tert-butyl peroxide, tert-butyl peroxy benzoate, 2-phenyl imidazoline, 2-methylimidazole, 2-vinyl-4-methylimidazole, 2-undecylimidazole, 2-heptadecylimidazole, 2-phenyl imidazole, 1-benzyl-2-methylimidazole, 1-cyanoethyl-2-vinyl-4-methylimidazole, 1-cyanoethyl-2-undecylimidazole, 1-cyanoethyl-2-undecylimidazole trimellitic acid salt, 1-cyanoethyl-2-phenylimidazole trimellitic acid salt, 2-methylimidazole tri-polyisocyanate, 2,4-diamino-6-(2-methylimidazole-1-ethyl)-S-triazine, 2,4-diamino-6-(2-ethyl-4-methylimidazole-1-ethyl)-S-triazine, 2,4-diamino-6-(2-undecylimidazole-1-ethyl)-S-triazine, 2-phenyl-4,5-bis(hydroxymethyl) imidazole, 2-phenyl-4-methyl-5-hydroxylmethyl imidazole, 1-cyanoethyl-2-phenyl-4,5-bis(cyanoethyl oxymethylene) imidazole, 1-dodecyl-2-methyl-3-benzylimidazole chloride, 1,3-dibenzyl-2-methylimidazole chloride, polyamide resin with a relative molecular mass of 200-1000, aniline-formaldehyde resin with a molecular weight of 200-600, dicyandiamide, methylphenyl biguanide, 2,5-dimethyl phenyl biguanide, diphenyl biguanide, phenyl biguanide, benzyl biguanide, dimethyl biguanide, a boron trifluoride-methylaniline complex, a boron trifluoride-monoethylamine complex, a boron trifluoride-benzylamine complex, boron trifluoride-2,4-dimethylaniline, a boron trifluoride-triphenyl phosphine complex, diaminomaleonitrile, 2,4,6-tri(dimethylamino methyl) phenol, tri(2-ethythexoic acid) salts of 2,4,6-tri(dimethylamino methyl) phenol, triphenylphosphine, methyl trioctylphosphine dimethyl phosphate, tetrabutyl phosphonium acetate, methyl tributyl phosphonium dimethyl phosphate, benzyl triphenylphosphonium chloride, tetrabutylphosphonium chloride, methyl triphenyl phosphonium dimethyl phosphate, ethyl-triphenylphosphonium iodide, benzyl triphenyl phosphonium bromide, tetrabutyl phosphonium bromide, triphenyl phosphonium triphenyl borate, a triphenyl phosphonium boron complex and tetraphenylphosphonium tetraphenyl boron.

The adhesive force accelerant is selected from: at least one of methytrimethoxysilane, methyl triethoxysilane, 3-aminopropyltriethoxysilane, 3-aminopropyltrimethoxysilane, γ-ureidopropyltriethoxysilane, anilmomethyl triethoxy silane, anilinomethyltrimethoxysilane, glycidyl 3-(trimethoxysilyl)propyl ether, (3-glycidyloxypropyl)triethoxysilane, 3-methylacrylethyl propyl trimethoxy silane, 3-methyl acryloyloxy propyl methyl diethoxy silane, 3-methyl acryloyloxy propyl methyl dimethoxy silane, N-2-aminoethyl-3-aminopropyl trimethoxy silane, N-2-aminoethyl-3-aminopropyl methyl dimethoxy silane, N-2-aminoethyl-3-aminopropyl methyl dimethoxy silane, bis-[γ-(triethoxy silicon)propyl]tetrasulfide, vinyl trimethoxy silane, vinyl tri(2-methoxy ethoxy) silane, vinyl triethoxy silane, γ-aminopropyl triethoxy silane, γ-(2,3-epoxypropoxy)propyl trimethoxy silane, γ-(2,3-epoxypropoxy)propyl triethoxy silane, γ-(2,3-epoxypropoxy)propyl methyl dimethoxy silane, γ-chloropropyl trichlorosilane, γ-chloropropyl methyl dichlorosilane, γ-chloropropyl trimethoxy silane, γ-chloropropyl triethoxysilane, chloromethyl trimethoxy silane, 1-(3,4-epoxy cyclohexyl)ethyl trimethoxy silane, 3-mercaptopropyl trimethoxy silane, 3-mercaptopropyl triethoxysilane, iso-propyl octyl tri-acyloxy titanate, tri-stearic acid titanic acid isopropyl ester, isopropyl tri(dioctyl phosphoric acid acyloxy) titanate, isopropyl tri-oleic phosphoric acid acyloxy titanate, bis(dioctyloxy pyrophosphate) ethylene titanate, isopropyl tri(dioctyloxy pyrophosphate acyloxy) titanate, dioctyloxy pyrophosphate acryloxy titanate, isopropyl dioctyl tetra-oleic phosphate titanate, tri-stearate titanate isopropyl ester, tetra-isopropyl bis(dioctyloxy phosphorous acid acyloxy) titanate, tetra-isopropoxy titanium, an aluminum-titanium composite coupling agent XY-AL82 and an aluminic acid ester coupling agent XY-AL81.

The releasing agent is selected from: at least one of liquid paraffin, paraffin, polyethylene wax with a relative molecular weight of 1000-5000, oxidized polyethylene wax, carnauba wax, stearate wax, lignite wax, palm wax, oleamide and erucyl amide.

The fire retardant is selected from: at least one of aluminum hydroxide, magnesium hydroxide, calcium hydroxide, barium hydroxide, nickel hydroxide, magnesium oxide, aluminum oxide, calcium oxide, antimonous oxide, calcium carbonate, red phosphorus, tri(chloroethyl)phosphate, tri(2,3-dichloropropyl)phosphate, tri(2,3-dibromopropyl) phosphate, decabromodiphenyl ether, 2,4,6-tribromoaniline, 3,5,3,5-tetrabromo-4,4-diamino diphenyl sulfone, N-(2,4,6-tribromophenyl)maleimide, penta-bromophenol glycidyl ether, tetrabromophthalic anhydride, triphenyl phosphate, tricresyl phosphate, diphenyl phosphate(2-ethylhexyl) ester, diphenyl phosphate(isopropyl phenyl) ester, diphenyl phosphate (p-tert-butylphenol) ester, phosphate bis(2-ethylhexyl) phenyl ester, tri-chloropropyl phosphate, tri-chloroethyl phosphate, bromine-containing epoxy resin with a grade of DER-542, DER-534, DER-511, DER-580, Epikote DX-245, Araldite-8011, Araldite-9147, Resin EPX-92, 123 or 145, tetraglycidyl-3,3′-diamino phenyl methyl phosphorus oxide, 1-[bis(2-chloroethoxy) phosphorus oxide methyl]-2,4-diaminobenzene, 1-[bis(2-chloroethoxy) phosphorus oxide methyl]-2,6-diaminobenzene, bis(4-amino phenoxyl] phenyl phosphorus oxide, bis(3-amino phenyl) phenyl phosphorus oxide, bis(3-amino phenyl) methyl phosphorus oxide, bis(3-amino phenyl) phosphorus oxide and bis(4-amino phenyl) phosphate.

The preparation method of the dielectric composite material for the fingerprint sensor induction layer comprises the following steps:

(1) following raw materials are weighed according to a mass percent: 4 to 20 percent of epoxy resin, 0.2 to 10 percent of phenolic resin, 35.27 to 90 percent of a first type of dielectric inorganic filler, 2 to 60 percent of a second type of dielectric inorganic filler, 0.01 to 5 percent of curing agent, 0.01 to 5 percent of adhesive force accelerant, 0.01 to 3 percent of releasing agent and 0.5 to 10 percent of fire retardant; and

(2) the epoxy resin, the first type of dielectric inorganic filler, the second type of dielectric inorganic filler and the adhesive force accelerant are mixed by a two-roll rubber mixer for 0.5 to 1 hour under the condition of 80° C.-150° C., and then the releasing agent and the fire retardant are added and then mixed for 1 to 5 minutes; the temperature is adjusted to 80° C.-120° C., phenolic resin and a catalyst are added, mixed uniformly for 1 to 10 minutes and then extruded into sheets, the sheets are cooled to a room temperature crushed to powder and then pellertized to tablet, then obtain the dielectric composite material for the fingerprint sensor induction layer.

A second preparation method of the dielectric composite material for the fingerprint sensor induction layer comprises the following steps:

(1) following raw materials are weighed according to a mass percent: 4 to 20 percent of epoxy resin, 0.2 to 10 percent of phenolic resin, 35.27 to 90 percent of a first type of dielectric inorganic filler, 2 to 60 percent of a second type of dielectric inorganic filler, 0.01 to 5 percent of curing agent, 0.01 to 5 percent of adhesive force accelerant, 0.01 to 3 percent of releasing agent and 0.5 to 10 percent of fire retardant; and

(2) various solid raw materials in step (1) are respectively ground into powder, the solid powder and liquid raw materials are mixed to be dispersed by a high-speed powder stirring kettle for 10 to 60 minutes, extruded by a single-screw extruder or a split-type dual-screw extruder, cooled by two rolls, cooled by a transfer belt, crushed into powder by a crusher, uniformly mixed by a homogenizing mixing vessel, and pellertized to tablets to obtain the dielectric composite material for the fingerprint sensor induction layer.

The present invention has the advantages:

the dielectric composite material for the fingerprint sensor induction layer is high in dielectric constant which is far higher than that of the ordinary composite material, relatively small in dielectric loss, very stable in dielectric performance, very small in variation along with a measuring frequency, very transparent and high in hardness, so that the thickness of the prepare fingerprint sensor induction layer meets the requirement, and the requirement on the reliability and the stability is also satisfied; and the dielectric composite material can be used in various portable electronic products. The dielectric composite material for the fingerprint sensor induction layer contains no heavy metal lead and is environmentally-friendly. The dielectric composite material has convenience and safety; therefore, a terminal application of the dielectric composite material not only can substitute the existing digital input password identification system, but also can be applied to any electronic device to be confidential, thereby providing a reliable warrant for the security in the future.

### DESCRIPTION OF THE DRAWINGS

FIG. 1 is a schematic diagram showing a dielectric composite material for a fingerprint sensor induction layer of the present invention completely encapsulating the fingerprint sensor.

FIG. 2 is a schematic diagram showing a material in prior art adopting a lens to encapsulate a fingerprint sensor.

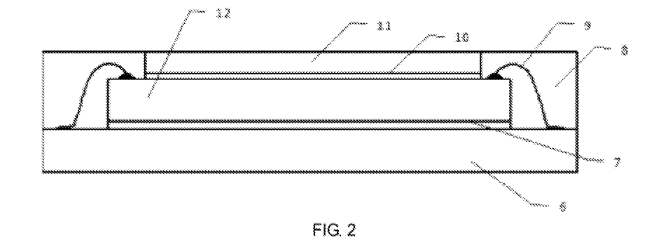

In the figures: 6 is an encapsulation substrate; 7 is a chip adhesive material; 8 is ordinary molding plastics; 9 is a bonding lead; 11 is a capacitive lens (glass, sapphire); 10 is resin adhesive; and 12 is a sensor chip.

FIG. 3 is a schematic diagram showing a material in prior art incompletely encapsulating a fingerprint sensor.

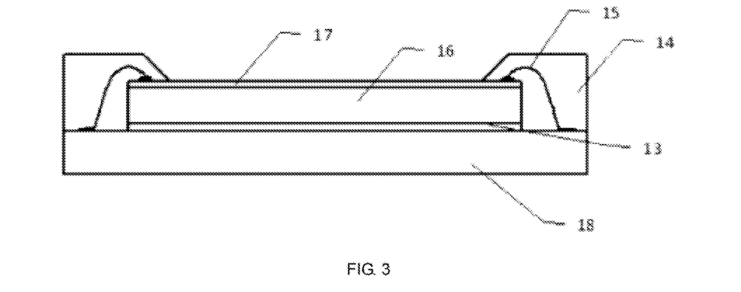

In the figures: 18 is an encapsulation substrate; 16 is a sensor chip: 13 is a chip adhesive material; 14 is ordinary molding plastics; 15 is a bonding lead; 17 is a protective thin layer (silicon nitride, silicon carbide, aluminum oxide, polyimide and the like).

### DETAILED DESCRIPTION OF PREFERRED EMBODIMENTS

The present invention is further described below in combination with specific embodiments. The following embodiments do not limit the present invention in any way; and any technical solution obtained by adopting a way of equivalent replacements or equivalent transformations shall fall within the protection scope of the present invention.

Bisphenol A-type epoxy resin:

GB/T13657-2011: grades are EPO1431310, EPO1441310, EPO1451310, EPO1551310, EPO1661310, EPO1671310 or EPO1691410;

KUKDO CHEMICAL (KUNSHAN) CO., LTD: grades are YDF-161, YDF-161H, YDF-162, YDF-165, YDF-170, YDF-175, YDF-175S, YDF-2001 and YDF-2004;

DOW CHEMICAL COMPANY: a grade is DER354;

HEXION COMPANY: grades are NPON862, NPON 863;

DIC COMPANY: grades are EPICLON 830, EPICLON 830S, EPICLON830LVP, EPICLON835 or EPICLON835LV);

hydrogenated bisphenol A-type epoxy resin:

KUKDO CHEMICAL (KUNSHAN) CO., LTD: grades are ST-1000, ST-3000, ST-4000D, ST40100D, ST-5080, ST-5100;

HEXION COMPANY: grade is EPONEX1510;

phenol formaldehyde epoxy resin:

WUXI RESIN FACTORY: grades are F-44, F-52, F-48;

cresol formaldehyde epoxy resin:

WUXI RESIN FACTORY: grades are FJ-47, FJ-43;

o-cresol formaldehyde epoxy resin:

DALIAN QIHUA CHEMICAL CO., LTD: grades are PGCN-700-2, PGCN-700-3, PGCN-701, PGCN-702, PGCN-703, PGCN-704L, PGCN-704ML, PGCN-704, PGCN-700-2S, PGCN-700-3S, PGCN-701S, PGCN-702S, PGCN-703S, PGCN-704S;

BLUESTAR CHEMICAL NEW MATERIAL CO. LTD: grades are JF-43, JF-45, JF-46;

Manufactured by CHANGCHUN CHEMICAL CORPORATION: the grade is CNE-195XL;

Manufactured by NIPPON STEEL CHEMICAL: the grades are KI-3000, KI-5000;

Biphenyl-type epoxy resin:

MITSUBISH CHEMICAL CORPORATION: the grades are YX-4000H, YX-4000K, YX4000H/K, YL6121H, YL6121H, YL6677, YX7399, YL6640;

phenolic resin:

ordinary phenolic resin: phenolic resin 2130, 2127, 2124, 2123, 2402;

GUN EI CHEMICAL CORPORATION: the grades are GS-180, GS-200;

ARAKAWA CHEMICAL INDUSTRIES LTD: the grades are P-180, P-200;

MEIWA PLASTIC INDUSTRIES LTD: the grades are H-1, H-4, HF-1M;

biphenyl-type phenolic resin:

MEIWA PLASTIC INDUSTRIES LTD: the grades are MEH-7851S, MEH-7851-3H, MEH-7852M, MEH-7853-SS;

p-tert-octyl phenoformaldehyde resin (TXN-203);

p-tert-butylphenol-formaldehyde resin (2402);

epoxy modified alkyl phenolic resin (TKM-O, SP1077, T6000, T3100);

cashew nut oil modified alkyl phenolic resin (SP6600(SP6700+HMT), SP6700, SL2201, SL2202, Durez12686, PFM-C, HRJ11995, PF221, PF222, PF223);

tall oil modified alkyl phenolic resin (SP6601(SP6701+HMT), SP6701, SL2101, SL2102, Durez13355, PFM-T, HRJ12532);

hydroxymethyl p-n-octylphenol formaldehyde resin (202, R17152, SP-1044, SP-10458);

bromo-hydroxymethyl p-n-octylphenol formaldehyde resin (201, SP-1055, SP-1056(high bromination);

Tackind250, P-124;

hydroxymethyl p-tert-butylphenol-formaldehyde resin 101, epoxy modified phenolic resin PF-231.

See table 1 about embodiments 1-39.

Table 1 shows component contents (by mass percent %) table (a number in brackets in the table is a content of a component); and when a component consists of two compounds, the ratio is a mass ratio

| | | | first type of | second type | | | | |
|---|---|---|---|---|---|---|---|---|
| | | | dielectric | of dielectric | | | | |
| Embodiment | epoxy resin | phenonic resin | inorganic filler | inorganic filler | curing agent | adhesive force accelerant | releasing agent | fire retardant |
| 1 | EP01433 | 2130, (3.47) | barium titanate | 1:1:1 silicon | ethylenediamine (0.01) | methyltrimethoxysilane (0.01) | liquid paraffin | aluminum hydroxide |
| | 310, (4) | | a (90) | dioxide with | | | (0.01) | (0.5) |
| | | | | a particle | | | | |
| | | | | size of c, d | | | | |
| | | | | and f (2) | | | | |
| 2 | EP01441 | GS-180, (2) | barium titanate | boron nitride | diethylenetriamine (5) | methyltrimethoxysilane (5) | liquid paraffin (3) | magnesium hydroxide |
| | 310, (20) | | b (50) | c (10) | | | | (5) |
| 3 | EP01451 | GS-200, (10) | barium titanate | calcium carbonate | triethylenetetramine (3) | 3-aminopropyltriethoxysilane | polyethylene wax | calcium hydroxide |
| | 310, (10) | | c (60) | (3) | | (3) | with relative mass | (10) |
| | | | | | | | molecular weight | |
| | | | | | | | of 1000 | |
| 4 | EP01551 | P-180, (0.2) | barium titanate | mica d (60) | tetraethytene pentamine (0.01) | 3-aminopropyltrimethoxysilane | polyethylene wax | magnesium oxide |
| | 310, (4) | | d (35.27) | | | (0.01) | with relative mass | (0.5) |
| | | | | | | | molecular weight | |
| | | | | | | | of 3000 (0.01) | |
| 5 | EP01661 | P-200, (3.47) | barium titanate | mica e (2) | pentaethylene hexamine (0.01) | γ-ureidopropyltriethoxysilane | polyethylene wax | calcium carbonate |
| | 310, (4) | | b (90) | | | (0.01) | with relative mass | (0.5) |
| | | | | | | | molecular weight | |
| | | | | | | | of 5000 (0.01) | |
| 6 | YDF-161, (20) | H-2, (2) | barium titanate | mica d (10) | piperazine (5) | anilmomethyltriethoxy silane | oxidized | red phosphorus (5) |
| | | | b | | | (5) | polyethylene wax | |
| 7 | YDF-161 | H-4, (10) | calcium copper | 1:1:1 silicon | N-aminoethyl piperazine (3) | anilinomethyltrimethoxysilane | carnauba wax (1) | tri(chloroethyl) |
| | H, (10) | | titanate | dioxide with | | (3) | | phosphate (10) |
| | | | b (60) | a particle | | | | |
| | | | | size of b, c | | | | |
| | | | | and d (3) | | | | |
| 8 | YDF-162, (4) | HF-1M, (3.47) | calcium copper | boron nitride | N-hydroxyethyl piperazine | grycidyl 3-trimethoxysilyl) | stearate wax | tri(2,3-dichloropropyl) |
| | | | titanate | d (2) | (0.01) | propyl ether (0.01) | (0.01) | phosphate (0.5) |
| | | | b (90) | | | | | |
| 9 | YDF-165, (4) | MEH-785 | copper calcium | calcium carbonat | m-phenylenediamine (0.01) | (3-grycidyloxypropyl) | lignite wax (0.01) | decabromodiphenyl |
| | | 1S, (0.2) | titranate e | b (60) | | triethoxysilane (0.01 | | ether (0.5) |
| | | | (35.27) | | | | | |
| 10 | YDF-170, (4) | TXN-203, (3.47) | copper calcium | mica e (2) | diamimodiphenyl-methane | 3-methylacrylethyl propyl | palm wax (0.01) | 2,4,6-tribromoaniline |
| | | | titanate | | (0.01) | trimethoxy silane (0.01) | | (0.5) |
| | | | c (90) | | | | | |
| 11 | DER354, (20) | 2402, (2) | copper calcium | titanium dioxide | IPDA (5) | 3-methyl acryloyloxy propyl | oleamide (3) | 3,5,3,5-tetrabromo- |
| | | | titanate | f (10) | | methyl diethoxy silane (5) | | 4,4-diamino diphenyl |
| | | | c (50) | | | | | sulfone (5) |
| 12 | NPON862, (10) | TKM-O, (10) | copper calcium | titanium dioxide | 1,3-bis (aminomethyl) | 3-methyl acryloyloxy propyl | erucyl amide (1) | N-(2,4,6- |
| | | | titanate | f (3) | cyclohexane (3) | methyl dimethoxy silane (3) | | tribromophenyl) |
| | | | d (60) | | | | | maleimide (10) |
| 13 | EPICLON | SP1077, (3.47) | copper calcium | silicon dioxide | 4,4-diamino dicyclohexyl | N-2-aminoethyl-3-aminopropyl | liquid paraffin | penta-bromophenol |
| | 830, (4) | | titanate | d (2) | methane (0.01) | trimethoxy silane (0.01) | (0.01) | glycidyl ether (0.5) |
| | | | c (90) | | | | | |
| 14 | EPICLON | T6000, (1) | calcium titanate | 1:2:3 silicon | ethanediamine | N-2-aminoethyl-3-aminopropyl | paraffin (0.5) | tetrabromophthalic |
| | 830S, (8) | | c (80) | dioxide with a | bismaleimide (2) | methyl dimethoxy silane (1) | | anhydride (0.5) |
| | | | | particle size of | | | | |
| | | | | a, b and c (7) | | | | |
| 15 | ST-1000, (8) | SP6700, (1) | calcium titanate | boron nitride | hexamethylenediamine | N-2-aminoethyl-3-aminopropyl | polyethylene wax | triphenyl phosphate |
| | | | c (80) | c (7) | bismaleimid (2) | methyl dimethoxy silane (1) | with a relative | (0.5) |
| | | | | | | | molecular weight | |
| | | | | | | | of 1000 (0.5) | |
| 16 | ST-3000, (4) | SL2201, (3.47) | calcium titanate | calcium carbonate | m-phenylenediamine | bis-[γ-(triethoxy silicon)propyl] | polyethylene wax | tricresyl phosphate |
| | | | b (90) | f (2) | bismaleimid (0.01) | tetrasulfide (0.01) | with a relative | (0.5) |
| | | | | | | | molecular weight | |
| | | | | | | | of 3000 (0.01) | |
| 17 | EPONEK1 | Durez12 | calcium carbonate | silicon dioxide | p-aminophenol maleimide (3) | vinyl trimethoxyl silane (3) | relative molecular | Idiphenyl |
| | 510, (10) | 686, (10) | (60) | d (3) | | | weight of 5000 (1) | phosphate(2-ethylhexyl) |
| | | | | | | | | ester (10) |
| 18 | F-44, (4) | PFM-C, (3.47) | calcium titanate | 1:2:1silicon | diaminodiphenyl sulfone | vinyl tri(2-methoxy ethoxy) | oxidized | diphenyl phosphate |
| | | | b (90) | dioxide with a | (0.01) | silane (0.01) | polyethylene wax | (isopropyl phenyl) |
| | | | | particle size of | | | (0.01) | ester (0.5) |
| | | | | a, b, c (2) | | | | |
| 19 | F-52, (20) | HRJ1199 | barium strontium | 1:2:3 silicon | phthalazinone (5) | iso-propyl octyl tri-acyloxy | camauba wax (3) | diphenyl phosphate |
| | | 5, (2) | titanate b (50) | dioxide with a | | titanate (5) | | (p-tert-butylphenol) |
| | | | | particle size of | | | | ester (5) |
| | | | | b, c, d (10) | | | | |
| 20 | FJ-47, (4) | PF221, (3.47) | barium strontium | boron nitride | phthalic anhydride (0.01) | tri-stearic acid titanic acid | stearate wax | phosphate |
| | | | titanate b (90) | b (2) | | isopropyl ester (0.01) | (0.01) | bis (2-ethylhexyl) |
| | | | | | | | | phenyl ester (0.5) |
| 21 | PGCN-70 | SP6701, (1) | barium strontium | calcium carbonate | trimellitic anhydride (2) | isopropyl tri(dioctyl phosphoric | lignite wax (0.5) | tri-chloropropyl |
| | 0-2, (8) | | titanate f (80) | b (7) | | acid acyloxy) titanate (1) | | phosphate (0.5) |
| 22 | PGCN-70 | SL2101, (10) | barium strontium | 1:2:3 silicon | pyromellitic dianhydride (3) | isopropyl tri-oleic phosphoric | palm wax (1) | tri-chloroethyl |
| | 0-3, (10) | | titanate d (60) | dioxide with a | | acid acyloxy titanate (3) | | phosphate (10) |
| | | | | particle size of | | | | |
| | | | | c, d, f (3) | | | | |
| 23 | JF-43, (20) | Durez13 | barium strontium | silicon dioxide | hydrogenated pyromellitic | bis(dioctyloxy pyrophosphate) | oleamide (3) | DER-542, (5) |
| | | 355, (2) | titanate b (50) | f (10) | anhydride (5) | ethylene titanate (5) | | |
| 24 | JF-45, (4) | PFM-T, (3.47) | barium strontium | silicon dioxide | maleic anhydride (0.01) | isopropyl tri (dioctyloxy | erucyl amide | DER-534, (0.5) |
| | | | titanate a (90) | d (2) | | pyrophosphate acyloxy) | (0.01) | |
| | | | | | | titanate (0.01) | | |
| 25 | CNE-195 | HRJ1253 | copper calcium | 1:0.5:0.5 titanium | 1,8-diazepine | dioctyloxy pyrophosphate | liquid paraffin | DER-511, (5) |
| | XL, (20) | 2, (2) | titanate e (50) | dioxide f, silicon | bicyclo-[5,4,0]-7-undecene | acryloxy titanate (5) | and erucyl amide | |
| | | | | dioxide b (10) | (5) | | in a mass ratio | |
| | | | | | | | of 1:1 (3) | |
| 26 | KI-3000, (4) | 202, (3.47) | copper calcium | titanium dioxide | diazepine bicyclononene | isopropyl dioctyl tetra-oleic | paraffin (0.01) | DER-580, (0.5) |
| | | | titanate in a | b and boron | (0.01) | phosphate titanate (0.01) | | |
| | | | ratio of 3:1 (90) | nitrde d in a | | | | |
| | | | | ratio of 1:1 (2) | | | | |
| 27 | YX-4000 | R17152, (10) | copper calcium | titanium dioxide | benzoperoxide (3) | tri-stearate titanate isopropyl | polyethylene wax | Epikote |
| | H, (10) | | titanate c (60) | f and calcium | | ester (3) | with a relative | DX-245, (10) |
| | | | | titanate d in a | | | molecular weight | |
| | | | | ratio of 1:1 (3) | | | of 1000 | |
| 28 | YL6121H, (4) | SP-1044, (3.47) | copper calcium | titanium dioxide | di-tert-butyl peroxide (0.01) | tetra-isopropyl bis (dioctyloxy | polyethylene wax | Araldite-8011, (0.5) |
| | | | titanate c (90) | a (2) | | phosphorous acid acyloxy) | with a relative | |
| | | | | | | titanate (0.01) | molecular weight | |
| | | | | | | | of 3000 (0.01) | |
| 29 | bis(2,3-epoxycyclopentyl) | 201, (2) | calcium titanate | aluminum oxide | tert-butyl peroxy benzoate (5) | 3-mercaptopropyl | polyethylene wax | Araldite-9147, (5) |
| | ether (20) | | c (50) | d and titanium | | triethoxysilane (5) | with a relative | |
| | | | | dioxide a in a | | | molecular weight | |
| | | | | ratio of 1:1 (10) | | | of 5000 (3) | |
| 30 | vinyl cyclohexene | SP-1055, (10) | calcium titanate | aluminum oxide | 2-phenyl imidazoline (3) | 3-mercaptopropyl | oxidized | Resin |
| | di-epoxy | | c (60) | d (3) | | trimethoxy silane (3) | polyethylene | EPX-92, (10) |
| | compound (10) | | | | | | wax (1) | |
| 31 | hexanedioic acid bis | SP-1056, (1) | barium titanate | aluminum oxide | 2-methylimidazole (2) | β-(3,4-epoxy cyclohexyl)ethyl | carnauba wax | BROC, (0.5) |
| | (3,4-epoxy-6-methyl- | | c (80) | d and boron | | trimethoxy silane (1) | (0.5) | |
| | cyclohexanemethanoformate) | | | nitride b in a | | | | |
| | (8) | | | ratio of 1:1 (7) | | | | |
| 32 | dicyclopentadiene | Tackind | barium titanate | 1:1 aluminum | polyamide resin with a | chloromethyl trimethoxy | carnauba wax | 123 and 145 |
| | di-epoxy | 250, (3.17) | b (90) | oxide c and | relative molecular mass | silane and vinyl triethoxy | (0.01) | 1:1 (0.5) |
| | compound (4) | | | calcium carbonate | of 200 (0.01) | silane 1:1 (0.01) | | |
| | | | | c in a ratio | | | | |
| | | | | of 1:1 (2) | | | | |
| 33 | tetrahydrophthalic | P-124, (3.47) | barium titanate | calcium carbonate | methylphenyl biguanide | γ-chloropropyl triethoxysilane | lignite wax (0.01) | 145, (0.5) |
| | acid diglycidyl | | b (90) | c (2) | and dimethyl biguanide | (0.01) | | |
| | ester (4) | | | | 1:1 (0.1) | | | |
| 34 | cyclohexane-1,2-dicarboxylic | T3100, (2) | Barium titanate | aluminum oxide | boron | γ-chloropropyl trimethoxy | palm wax (3) | tetraglycidyl-3,3′- |
| | diglycidyl ester (20) | | c and calcium | a and silicon | trifluoride-methylaniline | silane (5) | | diamino phenyl |
| | | | titanate c in a | dioxide d in a | complex (5) | | | methyl phosphorus |
| | | | ratio of 1:1 (50) | ratio of 1:1 (10) | | | | oxide (5) |
| 35 | 4,5-epoxy | 101, (3.47) | barium titanate | boron nitride | boron | γ-chloropropyl methyl | oleamide (0.01) | 1-[bis(2-chloroethoxy) |
| | tetrahydrophthalic | | c and calcium | d (2) | trifluoride-2,4-dimethylaniline | dichlorosilane (0.01) | | phosphorus |
| | acid diglycidyl | | titanate c (90) | | (0.01) | | | oxide methyl]- |
| | ester (4) | | in a ratio of 1:1 | | | | | 2.4-diaminobenzene |
| | | | | | | | | (0.5) |
| 36 | bis((3,4-epoxy | 1:109 | barium titanate | calcium carbonate | boron | γ-chloropropyl trichlorosilane | erucyl amide | 1-[bis(2-chloroethoxy) |
| | cyclohexyl) methyl) | PF-231 FU. | b and copper | d (7) | trifluoride-triphenyl | (1) | (0.5) | phosphorus oxide |
| | adipate (8) | SP-1045 | calcium titanate | | phosphine complex (2) | | | methyl]-2,6- |
| | | 8, (1) | in a ratio of 1:1 | | | | | diaminobenzene |
| | | | (80) | | | | | (0.5) |
| 37 | YX-4000k AND | SP-1045 | barium titanate | calcium carbonate | diaminomaleonitrile (0.01) | aluminic acid ester coupling | lignite wax (0.01) | bis(4-amino phenoxyl] |
| | yx7399 in a ratio | 8, (3.47) | c (90) | c and silicon | | agent XY-AL81, (0.01) | | phenyl phosphorus |
| | of 1:1 (4) | | | dioxide c in a | | | | oxide (0.5) |
| | | | | ratio of 1:1 (2) | | | | |
| 38 | YX4000H/K (8) | SL2102, (1) | barium titanate | calcium carbonate | 2,4,6-tri (dimethylamino | aluminum-titanium composite | palm wax (0.05) | bis(3-amino phenyl) |
| | | | c (80) | e (7) | methyl) phenol (2) | coupling agent XY-AL82 (1) | | phenyl phosphorus |
| | | | | | | | | oxide (0.5) |
| 39 | YX7390 (4) | SL2202, (3.47) | barium titanate | calcium carbonate | triphenylphosphine and boron | tetra-isopropoxy titanium | oleamide (0.01) | bis(3-amino phenyl) |
| | | | a (90) | c (2) | trifluoride-triphenyl | (0.01) | | methyl phosphorus |
| | | | | | phosphine complex | | | oxide (0.5) |
| | | | | | 1:1 (0.01) | | | |

In table 1, a refers to a maximum particle size less than 100 μm, and an average particle size is 0.8 μm;

b refers to a maximum particle size less than 100 μm, and an average particle size is 2 μm;

c refers to a maximum particle size less than 100 μm, and an average particle size is 10 μm;

d refers to a maximum particle size less than 100 μm, and an average particle size is 15 μm;

e refers to a maximum particle size less than 100 μm, and an average particle size is 50 μm; and

f refers to a maximum particle size less than 100 μm, and an average particle size is 5 μm. EPO1671 310, EPO1691 410, YDF-175, YDF-175S, YDF-2001, YDF-2004, NPON863, EPICLON830LVP, EPICLON835, EPICLON835LV, ST-4000D, ST-40100D, ST-5080, ST-5100, F-48, FJ-43, PGCN-701, PGCN-702, PGCN-703, PGCN-704L, PGCN-704ML, PGCN-704, PGCN-700-2S, PGCN-700-3S, PGCN-701S, PGCN-702S, PGCN-703S, PGCN-704S, JF-46, KI-5000, YL6677, YL6640, 3,4-epoxy-6-methyl cyclohexanecarboxylic acid-3′,4′-epoxy-6′-methyl cyclohexyl formate, 3,4-epoxy cyclohexanecarboxylic acid-3′,4′-epoxy cyclohexyl formate, a di-isoprene di-epoxy compound, 1,2-epoxy-4-vinyl cyclohexane, 3,4-epoxy cyclohexyl methyl methacrylate, 1,4-cyclohexane dimethyl carbinol bis(3,4-epoxy cyclohexanecarboxylic acid) ester and 3-epoxy ethyl1,2-cyclohexene oxide are used to respectively substitute EPO1431310 in embodiment 1 to form a new embodiment with other components unchanged.

2127, 2124, 2123, 2402, MEH-7851-3H, MEH-7852M, MEH-7853-SS, SP6600(SP6700+HMT), PF222, PF223 and SP6601(SP6701+HMT) are used to substitute GS-180 in embodiment 2 to form a new embodiment with other components unchanged.

O-phenylenediamine, tung oil anhydride, dodecenyl succinic anhydride, tetrahydrophthalic anhydride, methyltetrahydrophthalic anhydride, hexahydrophthalic anhydride, methylhexahydrophthalic anhydride, nadic anhydride, methyl nadic anhydride, glutaric anhydride, hydrogenated methyl nadic anhydride, methyl cyclohexene tetracarboxylic dianhydride, polyazelaic polyanhydride, polysebacic polyanhydride, 1,4,5,6-tetrabromophthalic anhydride, 2-vinyl-4-methylimidazole, 2-undecylimidazole, 2-heptadecylimidazole, 2-phenyl imidazole, 1-benzyl-2-methylimidazole, 1-cyanoethyl-2-vinyl-4-methylimidazole, 1-cyanoethyl-2-undecylimidazole, 1-cyanoethyl-2-undecylimidazole trimellitic acid salt, 1-cyanoethyl-2-phenylimidazole trimellitic acid salt, 2-methylimidazole tri-polyisocyanate, 2,4-diamino-6-(2-methylimidazole-1-ethyl)-S-triazine, 2,4-diamino-6-(2-ethyl-4-methylimidazole-1-ethyl)-S-triazine, 2,4-diamino-6-(2-undecylimidazole-1-ethyl)-S-triazine, 2-phenyl-4,5-bis(hydroxymethyl) imidazole, 2-phenyl-4-methyl-5-hydroxylmethyl imidazole, 1-cyanoethyl-2-phenyl-4,5-bis(cyanoethyl oxymethylene) imidazole, 1-dodecyl-2-methyl-3-benzylimidazole chloride, 1,3-dibenzyl-2-methylimidazole chloride, polyamide resin with a relative molecular mass of 1000, 2,5-dimethyl phenyl biguanide, diphenyl biguanide, phenyl biguanide, benzyl biguanide, a boron trifluoride-monoethylamine complex, a boron trifluoride-benzylamine complex, tri(2-ethylhexoic acid) salts of 2,4,6-tri(dimethylamino methyl) phenol, methyl trioctylphosphine dimethyl phosphate, tetrabutyl phosphonium acetate, methyl tributyl phosphonium dimethyl phosphate, benzyl triphenylphosphonium chloride, tetrabutylphosphonium chloride, methyl triphenyl phosphonium dimethyl phosphate, ethyl-triphenylphosphonium iodide, benzyl triphenyl phosphonium bromide, tetrabutyl phosphonium bromide, triphenyl phosphonium triphenyl borate, a triphenyl phosphonium boron complex and diamine dimaleic acid of tetraphenylphosphonium tetraphenyl boron amine are used to substitute ethylenimine in embodiment 14 to form a new embodiment with other components unchanged.

γ-aminopropyltriethoxy silane, γ-(2,3-epoxypropoxy)propyltrimethoxy silane, γ-(2,3-epoxypropoxy)propyl triethoxy silane and γ-(2,3-epoxypropoxy)propyl methyl dimethoxysilane are respectively used to substitute 3-aminopropyltriethoxy silane in embodiment 3 to form a new embodiment with other components unchanged.

Barium hydroxide, nickel hydroxide, aluminum oxide, calcium oxide, antimonous oxide, tri(2,3-dibromopropyl) phosphate, bis(3-aminophenyl)phosphine oxide and bis(4-aminophenyl) phosphate are respectively used to substitute calcium carbonate in embodiment 5 to form a new embodiment with other components unchanged.

### Embodiment 1-1

Preparation of the Dielectric Composite Material for the Fingerprint Sensor Induction Layer.

a small-batch preparation method of the dielectric composite material:

(1) raw materials are weighed according to embodiment 1;

(2) the epoxy resin, the first type of dielectric inorganic filler, the second type of dielectric inorganic filler and the adhesive force accelerant are mixed by a two-roll rubber mixing mill for 0.5 hour under the condition of 150° C., and then the releasing agent and the fire retardant are added and mixed for 1 minute; the temperature is adjusted to 80° C., and the phenolic resin and a catalyst are added, mixed uniformly for 10 minutes and then extruded into sheets, the sheets are cooled to a room temperature, crushed and compacted into tablets to obtain the dielectric composite material for the fingerprint sensor induction layer, and the dielectric composite material is stored in a refrigerator at a temperature less than 0 for standby use.

The technological parameters are identical to embodiment 1-1 in table 2.

With respect to embodiment 1-1 in table 2, the number 1 in front of “-” in “1-1” refers to a raw material formula of embodiment 1, while “1” behind “-” represents the dielectric composite material for the fingerprint sensor induction layer prepared by adopting the technological parameters in table 2 according to the above method.

With respect to embodiment 1-2 in table 2, the number 1 in “1-2” refers to a raw material formula of embodiment 1, while “2” represents the dielectric composite material for the fingerprint sensor induction layer prepared by adopting the technological parameters in table 2 according to the above method.

All embodiments in table 2 are interpreted in this way.

TABLE 2
Technological parameters of preparation of the dielectric composite material for a fingerprint sensor
induction layer.

| Embodiment | | Epoxy resin, | | Adding the | | |
|---|---|---|---|---|---|---|
| of the dielectric | | inorganic filler | | releasing | | Adding |
| composite | | and adhesive | | agent | | phenoic |
| material for the | Refer to the | force accelerant, | | and the fire | | resin and the |
| induction layer | emdodiment | mixing | mixing | retardant, | Adjusting | curing agent, |
| of the fingerprint | of table 1 about | temperature | time | mixing time | temperature | mixing time |
| sensor | the formula | (° C.) | (hour) | (minute) | (° C.) | (minute) |
| Embodiment 1-1 | Embodiment 1 | 150 | 0.5 | 1 | 80 | 10 |
| Embodiment 1-2 | Embodiment 1 | 130 | 0.5 | 2 | 80 | 10 |
| Embodiment 1-3 | Embodiment 1 | 110 | 0.5 | 3 | 120 | 1 |
| Embodiment 1-4 | Embodiment 1 | 100 | 0.5 | 4 | 120 | 1 |
| Embodiment 1-5 | Embodiment 1 | 90 | 0.7 | 5 | 100 | 5 |
| Embodiment 1-6 | Embodiment 1 | 90 | 0.7 | 5 | 100 | 5 |
| Embodiment 1-7 | Embodiment 1 | 90 | 0.8 | 5 | 90 | 6 |
| Embodiment 1-8 | Embodiment 1 | 90 | 0.8 | 5 | 90 | 6 |
| Embodiment 2-1 | Embodiment 2 | 150 | 0.5 | 1 | 80 | 10 |
| Embodiment 2-2 | Embodiment 2 | 130 | 0.5 | 2 | 80 | 10 |
| Embodiment 2-3 | Embodiment 2 | 110 | 0.5 | 3 | 120 | 1 |
| Embodiment 2-4 | Embodiment 2 | 100 | 0.5 | 4 | 120 | 1 |
| Embodiment 2-5 | Embodiment 2 | 90 | 0.7 | 5 | 100 | 5 |
| Embodiment 2-6 | Emoodiment 2 | 90 | 0.7 | 5 | 100 | 5 |
| Embodiment 2-7 | Embodiment 2 | 90 | 0.8 | 5 | 90 | 6 |
| Embodiment 2-8 | Embodiment 2 | 90 | 0.8 | 5 | 90 | 6 |
| Embodiment 1-9 | Embodiment 1 | 80 | 1 | 1 | 80 | 10 |
| Embodiment 2-9 | Embodiment 2 | 80 | 1 | 2 | 80 | 10 |
| Embodiment 3-9 | Embodiment 3 | 80 | 1 | 3 | 120 | 1 |
| Embodiment 4-9 | Embodiment 4 | 80 | 1 | 4 | 120 | 1 |
| Embodiment 5-9 | Embodiment 5 | 80 | 1 | 5 | 100 | 5 |
| Embodiment 6-9 | Embodiment 6 | 80 | 1 | 5 | 100 | 5 |
| Embodiment 7-9 | Embodiment 7 | 80 | 1 | 5 | 90 | 6 |
| Embodiment 8-9 | Embodiment 8 | 80 | 1 | 5 | 90 | 6 |
| Embodiment 9-9 | Embodiment 9 | 80 | 1 | 3 | 80 | 8 |
| Embodiment 10-9 | Embodiment 10 | 80 | 1 | 3 | 80 | 8 |
| Embodiment 11-9 | Embodiment 11 | 80 | 1 | 5 | 80 | 8 |
| Embodiment 12-9 | Embodiment 12 | 80 | 1 | 5 | 80 | 8 |
| Embodiment 13-9 | Embodiment 13 | 80 | 1 | 5 | 110 | 3 |
| Embodiment 14-9 | Embodiment 14 | 80 | 1 | 3 | 110 | 3 |
| Embodiment 15-9 | Embodiment 15 | 80 | 1 | 3 | 100 | 5 |
| Embodiment 16-9 | Embodiment 16 | 80 | 1 | 3 | 80 | 8 |
| Embodiment 17-9 | Embodiment 17 | 80 | 1 | 3 | 80 | 8 |
| Embodiment 18-9 | Embodiment 18 | 80 | 1 | 3 | 80 | 8 |
| Embodiment 19-9 | Embodiment 19 | 80 | 1 | 3 | 80 | 8 |
| Embodiment 20-9 | Embodiment 20 | 80 | 1 | 3 | 80 | 10 |
| Embodiment 21-9 | Embodiment 21 | 80 | 1 | 3 | 80 | 10 |
| Embodiment 22-9 | Embodiment 22 | 80 | 1 | 5 | 80 | 10 |
| Embodiment 23-9 | Embodiment 23 | 80 | 1 | 5 | 80 | 10 |
| Embodiment 24-9 | Embodiment 24 | 80 | 1 | 5 | 80 | 10 |
| Embodiment 25-9 | Embodiment 25 | 80 | 1 | 5 | 80 | 10 |
| Embodiment 26-9 | Embodiment 26 | 80 | 1 | 5 | 80 | 10 |
| Embodiment 27-9 | Embodiment 27 | 80 | 1 | 5 | 80 | 10 |
| Embodiment 28-9 | Embodiment 28 | 80 | 1 | 5 | 80 | 10 |
| Embodiment 29-9 | Embodiment 29 | 80 | 1 | 5 | 80 | 10 |
| Embodiment 30-9 | Embodiment 30 | 80 | 1 | 5 | 80 | 10 |
| Embodiment 31-9 | Embodiment 31 | 80 | 1 | 5 | 80 | 10 |
| Embodiment 32-9 | Embodiment 32 | 80 | 1 | 5 | 80 | 10 |
| Embodiment 33-9 | Embodiment 33 | 80 | 1 | 5 | 80 | 10 |
| Embodiment 34-9 | Embodiment 34 | 80 | 1 | 5 | 80 | 10 |
| Embodiment 35-9 | Embodiment 35 | 80 | 1 | 5 | 80 | 10 |
| Embodiment 36-9 | Embodiment 36 | 80 | 1 | 5 | 80 | 10 |
| Embodiment 37-9 | Embodiment 37 | 80 | 1 | 5 | 80 | 10 |
| Embodiment 38-9 | Embodiment 38 | 80 | 1 | 5 | 80 | 10 |
| Embodiment 39-9 | Embodiment 39 | 80 | 1 | 5 | 80 | 10 |

### Embodiment 40

An Application Method of a Dielectric Composite Material for a Fingerprint Sensor Induction Layer:

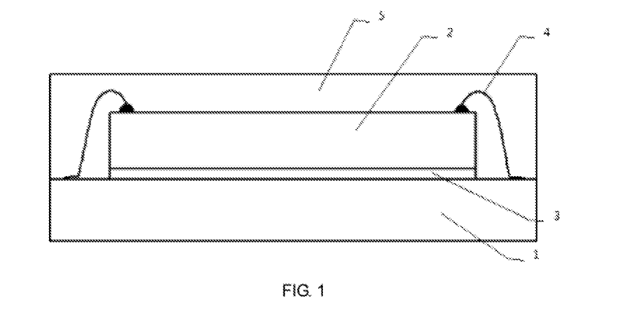

The dielectric composite material for the fingerprint sensor induction layer covers a fingerprint sensor chip through a high-temperature mold pressing molding method (molded in a hydraulic method), and the dielectric composite material for the fingerprint sensor induction layer is completely cured by means of heating curing, so that the fingerprint sensor chip can sense an electric signal on fingerprints so as to finally identify different fingerprint patterns, and the dielectric composite material can be well applied to the fingerprint sensor (refer to FIG. 1).

In FIG. 1, 1 is an encapsulation substrate; 2 is a sensor chip; 3 is a chip adhesive material; 4 is a bonding lead; and 5 is a dielectric composite material for the fingerprint sensor induction layer of the present invention.

### Embodiment 41

Table 3 properties of the dielectric composite material for the fingerprint sensor induction layer.

| The dielectric composite | Gelation time (t) | |
|---|---|---|
| material for the induction | measured | spiral following |
| layer of the fingerprint | temperature | length (mm), measured |
| sensor prepared by table 2 | 175° C. | temperature 175° C. |
| Embodiment 1-9 | 42 | 73 |
| Embodiment 2-9 | 30 | 120 |
| Embodiment 3-9 | 35 | 110 |
| Embodiment 4-9 | 60 | 65 |
| Embodiment 5-9 | 65 | 55 |
| Embodiment 6-9 | 35 | 65 |
| Embodiment 7-9 | 33 | 140 |
| Embodiment 8-9 | 70 | 100 |
| Embodiment 9-9 | 60 | 85 |
| Embodiment 10-9 | 55 | 153 |
| Embodiment 11-9 | 38 | 120 |
| Embodiment 12-9 | 35 | 110 |
| Embodiment 13-9 | 60 | 130 |
| Embodiment 14-9 | 30 | 94 |
| Embodiment 15-9 | 37 | 88 |
| Embodiment 16-9 | 60 | 110 |
| Embodiment 17-9 | 35 | 140 |
| Embodiment 18-9 | 55 | 120 |
| Embodiment 19-9 | 45 | 150 |
| Embodiment 20-9 | 65 | 135 |
| Embodiment 21-9 | 42 | 120 |
| Embodiment 22-9 | 35 | 140 |
| Embodiment 23-9 | 35 | 110 |
| Embodiment 24-9 | 60 | 155 |
| Embodiment 25-9 | 30 | 95 |
| Embodiment 26-9 | 55 | 95 |
| Embodiment 27-9 | 50 | 100 |
| Embodiment 28-9 | 60 | 95 |
| Embodiment 29-9 | 55 | 85 |
| Embodiment 30-9 | 30 | 80 |
| Embodiment 31-9 | 32 | 105 |
| Embodiment 32-9 | 55 | 120 |
| Embodiment 33-9 | 65 | 110 |
| Embodiment 34-9 | 30 | 60 |
| Embodiment 35-9 | 62 | 120 |
| Embodiment 36-9 | 30 | 100 |
| Embodiment 37-9 | 60 | 110 |
| Embodiment 38-9 | 35 | 120 |
| Embodiment 39-9 | 45 | 120 |

A maximum particle size of the first type and second type of dielectric inorganic filler of the dielectric composite material for the fingerprint sensor induction layer is respectively less than 100 μm, an average particle size is between 0.8 μm and 50 μm, and the dielectric composite materials of different particle sizes are combined to use, so that a spiral flowing length of the prepared dielectric composite material for the fingerprint sensor induction layer is longer, and the flowing effect is better.

TABLE 4
encapsulation performance of the dielectric composite
material for the fingerprint sensor induction layer.

| Dielectric composite | | | | | | Fingerprint |
|---|---|---|---|---|---|---|
| material for the | | | | | | Identification |
| induction layer of the | Dielectric | Dielectric | Dielectric | Dielectric | | effect |
| fingerprint sensor | constant | loss @ | constant | loss @ | Transparent | (thickness |
| prepared by table 2 | @ 1 KHz | 1 KHz | @ 2 MHz | 2 MHz | or not | 200 μm) |
| Embodiment 1-9 | 15.56 | 0.004 | 15.87 | 0.005 | No | Good |
| Embodiment 2-9 | 5.87 | 0.001 | 6.50 | 0.001 | No | Relatively good |
| Embodiment 3-9 | 7.65 | 0.001 | 7.85 | 0.001 | No | Relatively good |
| Embodiment 4-9 | 5.43 | 0.001 | 5.47 | 0.001 | No | Relatively good |
| Embodiment 5-9 | 22.48 | 0.004 | 22.95 | 0.005 | No | Good |
| Embodiment 6-9 | 5.95 | 0.001 | 6.12 | 0.001 | No | Relatively good |
| Embodiment 7-9 | 15.54 | 0.003 | 15.78 | 0.004 | No | Good |
| Embodiment 8-9 | 25.20 | 0.005 | 25.47 | 0.005 | No | Good |
| Embodiment 9-9 | 9.43 | 0.002 | 9.87 | 0.003 | No | Good |
| Embodiment 10-9 | 25.56 | 0.005 | 25.87 | 0.005 | No | Good |
| Embodiment 11-9 | 13.56 | 0.004 | 13.87 | 0.005 | No | Good |
| Embodiment 12-9 | 15.87 | 0.004 | 16.10 | 0.005 | No | Good |
| Embodiment 13-9 | 26.65 | 0.005 | 26.85 | 0.005 | No | Good |
| Embodiment 14-9 | 15.46 | 0.003 | 15.69 | 0.003 | No | Good |
| Embodiment 15-9 | 10.43 | 0.002 | 10.49 | 0.002 | No | Good |
| Embodiment 16-9 | 22.55 | 0.004 | 22.70 | 0.004 | No | Good |
| Embodiment 17-9 | 15.64 | 0.003 | 15.88 | 0.003 | No | Good |
| Embodiment 18-9 | 18.98 | 0.004 | 19.22 | 0.005 | No | Good |
| Embodiment 19-9 | 14.47 | 0.003 | 14.68 | 0.003 | No | Good |
| Embodiment 20-9 | 25.66 | 0.004 | 25.89 | 0.005 | No | Good |
| Embodiment 21-9 | 16.56 | 0.004 | 16.77 | 0.005 | No | Good |
| Embodiment 22-9 | 13.57 | 0.003 | 13.80 | 0.003 | No | Good |
| Embodiment 23-9 | 11.65 | 0.002 | 11.85 | 0.002 | No | Good |
| Embodiment 24-9 | 25.43 | 0.004 | 25.47 | 0.004 | No | Good |
| Embodiment 25-9 | 8.15 | 0.001 | 8.17 | 0.001 | No | Relatively good |
| Embodiment 26-9 | 23.20 | 0.001 | 23.25 | 0.001 | No | Good |
| Embodiment 27-9 | 9.23 | 0.002 | 9.25 | 0.002 | No | Relatively good |
| Embodiment 28-9 | 23.73 | 0.004 | 23.74 | 0.004 | No | Good |
| Embodiment 29-9 | 5.43 | 0.001 | 5.47 | 0.001 | No | Relatively good |
| Embodiment 30-9 | 6.06 | 0.001 | 6.07 | 0.001 | No | Relatively good |
| Embodiment 31-9 | 9.06 | 0.001 | 9.07 | 0.001 | No | Relatively good |
| Embodiment 32-9 | 19.08 | 0.003 | 19.09 | 0.003 | No | Good |
| Embodiment 33-9 | 19.00 | 0.003 | 19.00 | 0.003 | No | Good |
| Embodiment 34-9 | 5.55 | 0.001 | 5.57 | 0.001 | No | Relatively good |
| Embodiment 35-9 | 10.05 | 0.001 | 10.09 | 0.001 | No | Good |
| Embodiment 36-9 | 8.93 | 0.001 | 8.97 | 0.001 | No | Good |
| Embodiment 37-9 | 23.33 | 0.004 | 22.48 | 0.004 | No | Good |
| Embodiment 38-9 | 18.20 | 0.003 | 18.29 | 0.003 | No | Good |
| Embodiment 39-9 | 21.77 | 0.004 | 21.92 | 0.004 | No | Good |

A thickness of the dielectric composite material for the fingerprint sensor induction layer is 200 μm, the curing condition is 170° C., and the curing time is 200 seconds. The hardness of the cured composite material prepared in embodiments 5, 8, 10, 13, 16, 20, 24, 26, 28 and 37 reaches 90D or more, the protection performance is good, and the reliability is high.

### Embodiment 42

The dielectric composite material for the fingerprint sensor induction layer of the present invention is compared with a material in prior art.

Comparison information of different types of fingerprint sensors are listed in the following table.

Table 5 comparison between the dielectric composite material for the fingerprint sensor induction layer of the present invention and prior art.

| | Complete encapsulation type | | |
|---|---|---|---|
| | composite materials prepared | incomplete encapsulation type | |
| | in embodiments 5-9, 8-9, 10-9, | world patents | |
| | 13-9, 16-9, 20-9, 24-9, 26-9, and | WO2003098541, | |
| | 37-9) in table 2 are respectively | U.S. Pat. No. 6,091,082, | |
| | used to encapsulate in a high- | EP1256899, | Lens encapsulation type |
| | temperature molding injection | U.S. Pat. No. 6,114,862, | world patent |
| PDS type | method | U.S. Pat. No. 6,515,488 | WO20111304093 |
| Thickness of induction layer (μm) | 200 | <10 | >20 |
| Dielectric constant of induction | >20 | <10 | <10 |
| layer material(@1K Hz) | | | |
| Dielectric loss of induction layer | <0.01 | Uncertainty | Uncertainty |
| material(@1K Hz) | | | |
| Examples of main | Small-cited protable | Middle-large sized consumption | Small cited portable |
| applications | consumption-type electronic | electronic products such as | consumption type electronic |
| | products such as mobile phone | computers including a desktop | products such as a mobile phone |
| | PAD and the like | computer and a notebook | PAD and the like |
| | | computer | |

### Embodiment 43

Preparation of the Dielectric Composite Material for the Fingerprint Sensor Induction Layer

a large-scale preparation method of the dielectric composite material:

(1) raw materials are weighed according to components by mass percent of embodiment 1 and are totaled in 500 kilograms;

(2) various solid raw materials in step (1) are respectively ground into powder, the solid powder and liquid raw materials are mixed to be dispersed by a high-speed powder stirring kettle for 20 minutes, extruded by a single-screw extruder, cooled by two rolls, cooled by a transfer belt, crushed into powder by a crusher, uniformly mixed by a homogenizing mixing kettle, and compacted into tablets to obtain the dielectric composite material for the fingerprint sensor induction layer.

### Embodiment 44

Preparation of the Dielectric Composite Material for the Fingerprint Sensor Induction Layer.

the large-scale preparation method of the dielectric composite material:

(1) raw materials are weighed according to components by mass percent of embodiment 10 and are totaled in 1000 kilograms;

(2) various solid raw materials in step (1) are respectively ground into powder, the solid powder and liquid raw materials are mixed to be dispersed by a high-speed powder stirring kettle for 10 minutes, extruded by a single-screw extruder, cooled by two rolls, cooled by a transfer belt, crushed into powder by a crusher, uniformly mixed by a homogenizing mixing vessel, and compacted into tablets to obtain the dielectric composite material for the fingerprint sensor induction layer.

### Embodiment 45

Preparation of the Dielectric Composite Material for the Fingerprint Sensor Induction Layer

the large-scale preparation method of the dielectric composite material:

(1) raw materials are weighed according to components by mass percent of embodiment 13 and are totaled in 5000 kilograms;

(2) various solid raw materials in step (1) are respectively ground into powder, the solid powder and liquid raw materials are mixed to be dispersed by a high-speed powder stirring kettle for 30 minutes, extruded by a split-type dual-screw extruder, cooled by two rolls, cooled by a transfer belt, crushed into powder by a crusher, uniformly mixed by a homogenizing mixing vessel, and compacted into tablets to obtain the dielectric composite material for the fingerprint sensor induction layer.

### Embodiment 46

Preparation of the Dielectric Composite Material for the Fingerprint Sensor Induction Layer

the large-scale preparation method of the dielectric composite material:

(1) raw materials are weighed according to components by mass percent of embodiment 39 and are totaled in 1000 kilograms;

(2) various solid raw materials in step (1) are respectively ground into powder, the solid powder and liquid raw materials are mixed to be dispersed by a high-speed powder stirring kettle for 60 minutes, extruded by a split-type dual-screw extruder, cooled by two rolls, cooled by a transfer belt, crushed into powder by a crusher, uniformly mixed by a homogenizing mixing vessel, and compacted into tablets to obtain the dielectric composite material for the fingerprint sensor induction layer.

Experiments prove that the raw materials totaled in 500 kilograms are weighed by respectively utilizing each formula of embodiment 2, embodiment 3, embodiment 4, embodiment 5, embodiment 6, embodiment 7, embodiment 8, embodiment 9, embodiment 11, embodiment 12, embodiment 14, embodiment 15, embodiment 16, embodiment 17, embodiment 19, embodiment 19, embodiment 20, embodiment 21, embodiment 22, embodiment 23, embodiment 24, embodiment 25, embodiment 26, embodiment 27, embodiment 28, embodiment 29, embodiment 30, embodiment 31, embodiment 32, embodiment 33, embodiment 34, embodiment 35, embodiment 36, embodiment 37 and embodiment 38 and made into the corresponding dielectric composite material for the fingerprint sensor induction layer by adopting the method of step (2) of the present embodiment. The experiments prove that the properties and the encapsulation performance of the dielectric composite material for the fingerprint sensor induction layer prepared by the method are approximate to the properties and the encapsulation performance of a product prepared by the small-batch preparation method.

The dielectric composite material for the fingerprint sensor induction layer has high dielectric constant, enables the fingerprint sensor to sense the fingerprints under the situation that a material layer is relatively thick, has good reliability and stability, can be applied to various functional portable electronic products, and has high safety; and therefore, the terminal application of the dielectric composite material not only can substitute the existing digital input-type password identification system, but also can be applied to an electronic device to be confidential, thereby providing a reliable warrant to the safety in the future.

We claim:

1. A dielectric composite material for a fingerprint sensor induction layer, prepared from the following components by mass percent: 4 to 20 percent of epoxy resin, 0.2 to 10 percent of phenolic resin, 35.27 to 90 percent of a first type of dielectric inorganic filler, 2 to 60 percent of a second type of dielectric inorganic filler, 0.01 to 5 percent of curing agent, 0.01 to 5 percent of adhesive force accelerant, 0.01 to 3 percent of releasing agent and 0.5 to 10 percent of fire retardant.

2. The dielectric composite material for the fingerprint sensor induction layer according to claim 1, characterized in that the epoxy resin is: at least one of bisphenol A-type epoxy resin with a grade of EPO1431310, EPO1441310, EPO1451310, EPO1551310, EPO1661310, EPO1671310 or EPO1691410; or bisphenol F-type epoxy resin with a grade of YDF-161, YDF-161H, YDF-162, YDF-165, YDF-170, YDF-175, YDF-175S, YDF-2001, YDF-2004, DER354, NPON862, NPON863, EPICLON830, EPICLON830S, EPICLON830LVP, EPICLON835 or EPICLON835LV; or hydrogenated bisphenol A-type epoxy resin with a grade of ST-1000, ST-3000, ST-4000, ST-40100D, ST-5080, ST-5100 or EPONEX1510; or phenol formaldehyde epoxy resin with a grade of F-44, F-52 or F-48; or formaldehyde epoxy resin as shown by a grade FJ-47 or FJ-43; or o-cresol formaldehyde epoxy resin with a grade of PGCN-700-2, PGCN-700-3, PGCN-701, PGCN-702, PGCN-703, PGCN-704L, PGCN-704ML, PGCN-704, PGCN-700-2S, PGCN-700-3S, PGCN-701S, PGCN-702S, PGCN-703S, PGCN-704S, JF-43, JF-45, JF-46, CNE-195XL, KI-3000 and KI-5000; or biphenyl epoxy resin with a grade of YX-4000H, YX-4000K, YX-4000H/K, YL6121H, YL6677, YX7399 and YL6640; or bis(2,3-epoxycyclopentyl) ether, 3,4-epoxy-6-methyl cyclohexane carboxylic acid-3′,4′-epoxy-6′-methyl-cyclohexanemethano formate, a vinyl cyclohexene di-epoxy compound, 3,4-epoxy cyclohexanecarboxylic acid-3′4′-epoxycyclohexane carboxylate, a di-isoprene di-epoxy compound, hexanedioic acid bis(3,4-epoxy-6-methyl-cyclohexanemethano formate), a dicydopentadiene di-epoxy compound, tetrahydrophthalic acid diglycidyl ester, cydohexane-1,2-dicarboxylic diglycidyl ester, 4,5-epoxy tetrahydrophthalic acid diglycidyl ester, bis((3,4-epoxy cyclohexyl) methyl) adipate, 1,2-epoxy-4-vinyl cyclohexane, 3,4-epoxy cyclohexyl methyl methacrylate, 1,4-cyclohexanedimethanol dis(3,4-epoxy cyclohexanecarboxylic acid) ester and 3-oxiranyl 1,2-cyclohexene oxide.

3. The dielectric composite material for the fingerprint sensor induction layer according to claim 1, characterized in that the phenolic resin is: at least one of ordinary phenolic resin with a grade of 2130, 2127, 2124, 2123, 2402, GS-180, GS-200, P-180, P-200, H-1, H-4 or HF-1M; or biphenyl-type phenolic resin with a grade of MEH-7851S, MEH-7851-3H, MEH-7852M or MEH-7853-SS; or p-t-octylphenol formaldehyde resin with a grade of TXN-203; or p-tert-butylphenol formaldehyde resin with a grade of 2402; or epoxy modified alkyl phenolic resin with a grade of TKM-O, SP1077, T6000 or T3100; or cashew nut oil modified alkyl phenolic resin with a grade of SP6600 (sp6700+HMT), SP6700, SL2201, SL2202, urez12686, PFM-C, HRJ11995, PF221, PF222 and PF223; or tall oil modified alkyl phenolic resin as shown by SP6601(SP6701+HMT), SP6701, SL2101, SL2102, Durez13355, PFM-T and HRJ12532; or hydroxymethyl p-n-octylphenol formaldehyde resin with a grade of 202, R17152, SP-1044 or SP-10458; or bromo-hydroxymethyl p-n-octylphenol formaldehyde resin with a grade of 201, SP-1055, SP-1056, Tackind250 or P-124; or hydroxymethyl p-tert-butylphenol formaldehyde resin as shown by a grade 101; or epoxy modified phenolic resin with a grade of PF-231.

4. The dielectric composite material for the fingerprint sensor induction layer according to claim 1, characterized in that the first type of dielectric inorganic filler is: at least one of barium titanate, copper calcium titanate, calcium titanate and barium strontium titanate with a maximum particle size less than 100 μm and an average particle size between 0.8 μm to 50 μm.

5. The dielectric composite material for the fingerprint sensor induction layer according to claim 1, characterized in that the second type of dielectric inorganic filler is: at least one of titanium dioxide, aluminum oxide, silicon dioxide, boron nitride, calcium carbonate and mica with a maximum particle size less than 100 μm and an average particle size between 0.8 μm to 50 μm.

6. The dielectric composite material for the fingerprint sensor induction layer according to claim 1, characterized in that the curing agent is: at least one of ethylenediamine, diethylenetriamine, triethylenetetramine, tetraethylenepentamine, penten, piperazine, N-aminoethylpiperazine, N-hydroxyethyl piperazine, m-phenylenediamine, o-phenyenediamine, diaminodiphenyl-methane, ISOPHORONEDIAMINE (IPDA), 1, 3-bis(aminomethyl) cyclohexane, 4,4-diamino dicyclohexyl methane, ethanediamine bismaleimide, hexamethylenediamine bismaleimid, m-phenylenediamine bismaleimid, p-aminophenol maleimide, diaminodiphenyl sulfone, phthalazinone, phthalic anhydride, trimellitic anhydride, pyromellitic dianhydride, hydrogenated pyromellitic anhydride, maleic anhydride, tung oil anhydride, dodecenyl succinic anhydride, tetrahydrophthalic anhydride, methyltetrahydrophthalic anhydride, hexahydrophthalic anhydride, methylhexahydrophthalic anhydride, nadic anhydride, methyl nadic anhydride, glutaric anhydride, hydrogenated methyl nadic anhydride, methyl cyclohexene tetracarboxylic dianhydride, polyazelaic polyanhydride, polysebacic polyanhydride, 1,4,5,6-tetrabromophthalic anhydride, 1,8-diazepine bicyclo-[5,4,0]-7-undecene, diazepine bicyclo-nonene, benzoperoxide, di-tert-butyl peroxide, tert-butyl peroxy benzoate, 2-phenyl imidazoline, 2-methylimidazole, 2-vinyl-4-methylimidazole, 2-undecylimidazole, 2-heptadecylimidazole, 2-phenyl imidazole, 1-benzyl-2-methylimidazole, 1-cyanoethyl-2-vinyl-4-methylimidazole, 1-cyanoethyl-2-undecylimidazole, 1-cyanoethyl-2-undecylimidazole trimellitic acid salt, 1-cyanoethyl-2-phenylimidazole trimellitic acid salt, 2-methylimidazole tri-polyisocyanate, 2,4-diamino-6-(2-methylimidazole-1-ethyl)-S-triazine, 2,4-diamino-6-(2-ethyl-4-methylimidazole-1-ethyl)-S-triazine, 2,4-diamino-6-(2-undecylimidazole-1-ethyl)-S-triazine, 2-phenyl-4,5-bis(hydroxymethyl) imidazole, 2-phenyl-4-methyl-5-hydroxylmethyl imidazole, 1-cyanoethyl-2-phenyl-4,5-bis(cyanoethyl oxymethylene) imidazole, 1-dodecyl-2-methyl-3-benzylimidazole chloride, 1,3-dibenzyl-2-methylimidazole chloride, polyamide resin with a relative molecular mass of 200-1000, aniline-formaldehyde resin with a molecular weight of 200-600, dicyandiamide, methylphenyl biguanide, 2,5-dimethyl phenyl biguanide, diphenyl biguanide, phenyl biguanide, benzyl biguanide, dimethyl biguanide, a boron trifluoride-methylaniline complex, a boron trifluoride-monoethylamine complex, a boron trifluoride-benzylamine complex, boron trifluoride-2,4-dimethylaniline, a boron trifluoride-triphenyl phosphine complex, diaminomaleonitrile, 2,4,6-tri(dimethylamino methyl) phenol, tri(2-ethylhexoic acid) salts of 2,4,6-tri(dimethylamino methyl) phenol, triphenylphosphine, methyl trioctylphosphine dimethyl phosphate, tetrabutyl phosphonium acetate, methyl tributyl phosphonium dimethyl phosphate, benzyl triphenylphosphonium chloride, tetrabutylphosphonium chloride, methyl triphenyl phosphonium dimethyl phosphate, ethyl-triphenylphosphonium iodide, benzyl triphenyl phosphonium bromide, tetrabutyl phosphonium bromide, triphenyl phosphonium triphenyl borate, a triphenyl phosphonium boron complex and tetraphenylphosphonium tetraphenyl boron.

7. The dielectric composite material for the fingerprint sensor induction layer according to claim 1, characterized in that the adhesive force accelerant is at least one of methyltrimethoxysilane, methyl triethoxysilane, 3-aminopropyltriethoxysilane, 3-aminopropyltrimethoxysilane, γ-ureidopropyltriethoxysilane, anilmomethyl triethoxy silane, anilinomethyltrimethoxysilane, glycidyl 3-(trimethoxysilyl)propyl ether, (3-glycidyloxypropyl)triethoxysilane, 3-methylacrylethyl propyl trimethoxy silane, 3-methyl acryloyloxy propyl methyl diethoxy silane, 3-methyl acryloyloxy propyl methyl dimethoxy silane, N-2-aminoethyl-3-aminopropyl trimethoxy silane, N-2-aminoethyl-3-aminopropyl methyl dimethoxy silane, N-2-aminoethyl-3-aminopropyl methyl dimethoxy silane, bis-[γ-(triethoxy silicon)propyl]tetrasulfide, vinyl trimethoxy silane, vinyl tri(2-methoxy ethoxy) silane, vinyl triethoxy silane, γ-aminopropyl triethoxy silane, γ-(2,3-epoxypropoxy)propyl trimethoxy silane, γ-(2,3-epoxypropoxy)propyl triethoxy silane, γ-(2,3-epoxypropoxy)propyl methyl dimethoxy silane, γ-chloropropyl trichlorosilane, γ-chloropropyl methyl dichlorosilane, γ-chloropropyl trimethoxy silane, γ-chloropropyl triethoxysilane, chloromethyl trimethoxy silane, β-(3,4-epoxy cyclohexyl)ethyl trimethoxy silane, 3-mercaptopropyl trimethoxy silane, 3-mercaptopropyl triethoxysilane, iso-propyl octyl tri-acyloxy titanate, tri-stearic acid titanic acid isopropyl ester, isopropyl tri(dioctyl phosphoric acid acyloxy) titanate, isopropyl tri-oleic phosphoric acid acyloxy titanate, bis(dioctyloxy pyrophosphate) ethylene titanate, isopropyl tri(dioctyloxy pyrophosphate acyloxy) titanate, dioctyloxy pyrophosphate acryloxy titanate, isopropyl dioctyl tetra-oleic phosphate titanate, tri-stearate titanate isopropyl ester, tetra-isopropyl bis(dioctyloxy phosphorous acid acyloxy) titanate, tetra-isopropoxy titanium, an aluminum-titanium composite coupling agent XY-AL82 and an aluminic acid ester coupling agent XY-AL81.

8. The dielectric composite material for the fingerprint sensor induction layer according to claim 1, characterized in that the releasing agent is at least one of liquid paraffin, paraffin, polyethylene wax with a relative molecular weight of 1000-5000, oxidized polyethylene wax, carnauba wax, stearate wax, lignite wax, palm wax, oleamide and erucyl amide.

9. The dielectric composite material for the fingerprint sensor induction layer according to claim 1, characterized in that the fire retardant is at least one of aluminum hydroxide, magnesium hydroxide, calcium hydroxide, barium hydroxide, nickel hydroxide, magnesium oxide, aluminum oxide, calcium oxide, antimonous oxide, calcium carbonate, red phosphorus, tri(chloroethyl)phosphate, tri(2,3-dichloropropyl)phosphate, tri(2,3-dibromopropyl) phosphate, decabromodiphenyl ether, 2,4,6-tribromoaniline, 3,5,3,5-tetrabromo-4,4-diamino diphenyl sulfone, N-(2,4,6-tribromophenyl)maleimide, penta-bromophenol glycidyl ether, tetrabromophthalic anhydride, triphenyl phosphate, tricresyl phosphate, diphenyl phosphate(2-ethylhexyl) ester, diphenyl phosphate(isopropyl phenyl) ester, diphenyl phosphate (p-tert-butylphenol) ester, phosphate bis(2-ethylhexyl) phenyl ester, tri-chloropropyl phosphate, tri-chloroethyl phosphate, bromine-containing epoxy resin with a grade of DER-542, DER-534, DER-511, DER-580, Epikote DX-245, Araldite-8011, Araldite-9147, Resin EPX-92, 123 or 145, tetraglycidyl-3,3′-diamino phenyl methyl phosphorus oxide, 1-[bis(2-chloroethoxy) phosphorus oxide methyl]-2,4-diaminobenzene, 1-[bis(2-chloroethoxy) phosphorus oxide methyl]-2,6-diaminobenzene, bis(4-amino phenoxyl] phenyl phosphorus oxide, bis(3-amino phenyl) phenyl phosphorus oxide, bis(3-amino phenyl) methyl phosphorus oxide, bis(3-amino phenyl) phosphorus oxide and bis(4-amino phenyl) phosphate.

10. A preparation method of a dielectric composite material for a fingerprint sensor induction layer, characterized by comprising the following steps: (1) weighing by mass percent: 4 to 20 percent of epoxy resin, 0.2 to 10 percent of phenlic resin, 35.27 to 90 percent of a first type of dielectric inorganic filler, 2 to 60 percent of a second type of dielectric inorganic filler, 0.01 to 5 percent of curing agent, 0.01 to 5 percent of adhesive force accelerant, 0.01 to 3 percent of releasing agent, and 0.5 to 10 percent of fire retardant; (2) mixing the epoxy resin, the first type of dielectric inorganic filler, the second type of dielectric inorganic filler and the adhesive force accelerant for 0.5 to 1 hour by a two-roll mixer under a condition of 80° C.-150° C., adding the releasing agent and the fire retardant, and mixing for 1 to 5 minutes; and adjusting the temperature to 80° C.-120° C. adding the phenolic resin and a catalyst, mixing for 1 to 10 minutes until the matures are homogenized, extruding to form sheets, cooling to a room temperature, pulverizing, and compacting to obtain the dielectric composite material for the fingerprint sensor induction layer.

11. The preparation method of the dielectric composite material for the fingerprint sensor induction layer, characterized by comprising the following steps: (1) weighing by mass percent: 4 to 20 percent of epoxy resin, 0.2 to 10 percent of phenolic resin, 35.27 to 90 percent of a first type of dielectric inorganic filler, 2 to 60 percent of a second type of dielectric inorganic filler, 0.01 to 5 percent of curing agent, 0.01 to 5 percent of adhesive force accelerant, 0.01 to 3 percent of releasing agent, and 0.5 to 10 percent of fire retardant; and (2) respectively grinding various solid raw materials in step (1) into powder, mixing the solid powder and liquid raw materials, dispersing for 10 to 60 minutes by a high-speed powder stirring kettle, extruding by a single-screw extruder or a split-type dual-screw extruder, pulverizing by a crusher into powder after the materials are cooled by two rolls and a conveyor belt, and compacting to form tablets to obtain the dielectric composite material the fingerprint sensor induction layer after being uniformly mixed by a homogenizing mixing vessel.
